(19) United States
(12) Patent Application Publication
(10) Pub. No.: US 2025/0117443 A1
(43) Pub. Date: Apr. 10, 2025

(54) DATA DIFFERENCE EVALUATION VIA MODEL COMPARISON

(71) Applicant: International Business Machines Corporation, Armonk, NY (US)

(72) Inventors: Lei Tian, Xi'an (CN); Han Zhang, Xi'an (CN); Jing James Xu, Xi'an (CN); Xue Ying Zhang, Xi'an (CN); Si Er Han, Xi'an (CN)

(21) Appl. No.: 18/482,975

(22) Filed: Oct. 9, 2023

(51) Int. Cl. G06F 18/2325

(52) U.S. Cl. CPC G06F 18/2325

(57) ABSTRACT

A computer-implemented method for performing data difference evaluation is provided. Aspects include obtaining a first data set and a second data set, creating a first plurality of feature vectors by inputting the first data set into each of a plurality of models, and creating a second plurality of feature vectors by inputting the second data set into each of the plurality of models. Aspects also include identifying a mapping between elements of the first plurality of vectors and elements the second plurality of feature vectors created by a same model of the plurality of models, calculating, for each of the plurality of models based at least in part on the mapping, a model distance between the first data set and the second data set, and calculating, based at least in part on the model distances, an ensemble distance between first data set and the second data set.

### BACKGROUND

The present invention generally relates to data processing, and more specifically, to data difference evaluation via model comparison.

Data difference evaluation is a common problem in the data science area, especially in the area of data analysis. Data difference evaluation is often performed in conjunction with data simulation, data preparation, modeling, and data privacy protection. For example, in many cases a data set is generated for use in a simulation, in these cases it is important to ensure data similarity between the generated data and an original data set.

In other cases, data difference evaluation is used to identify differences between data sets. For example, in social media and e-commerce field, user data similarity can be used for building recommendation systems and targeted advertising. In the biomedical field, data similarity can be used for biological population difference analysis and medication design. In addition, in the finance and insurance fields, data similarity can be used for market trend and risk analysis.

### SUMMARY

Embodiments of the present invention are directed to a computer-implemented method for performing a data difference evaluation. The computer-implemented method includes obtaining a first data set and a second data set, inputting the first data set into each of a plurality of clustering models, wherein each of the plurality of clustering models separates the first data set into a different number of clusters, and storing an output of each of the plurality of clustering models corresponding to the first data set into a first plurality of cluster vectors, where each of the first plurality of cluster vectors has a dimension that corresponds to the number of clusters. The method also includes inputting the second data set into each of the plurality of clustering models, wherein each of the plurality of clustering models separates the second data set into a different number of clusters, storing the output of each of the plurality of clustering models corresponding to the second data set into a second plurality of cluster vectors, where each of the second plurality of cluster vectors has a dimension that corresponds to the number of clusters, and identifying a mapping between elements of the first plurality of cluster vectors and elements the second plurality of cluster vectors having a same dimension. The method also includes calculating, for each dimension based at least in part on the mapping, a dimensional distance between the first data set and the second data set and calculating, based at least in part on the dimensional distances, an ensemble distance between first data set and the second data set.

Embodiments of the present invention are directed to a computer program product for performing a data difference evaluation. The computer program product includes one or more computer readable storage media having computer readable program code collectively stored on the one or more computer readable storage media. The computer readable program code is executed by a processor of a computer system to cause the computer system to perform operations. The operations include obtaining a first data set and a second data set, inputting the first data set into each of a plurality of clustering models, wherein each of the plurality of clustering models separates the first data set into a different number of clusters, and storing an output of each of the plurality of clustering models corresponding to the first data set into a first plurality of cluster vectors, where each of the first plurality of cluster vectors has a dimension that corresponds to the number of clusters. The operations also include inputting the second data set into each of the plurality of clustering models, wherein each of the plurality of clustering models separates the second data set into a different number of clusters, storing the output of each of the plurality of clustering models corresponding to the second data set into a second plurality of cluster vectors, where each of the second plurality of cluster vectors has a dimension that corresponds to the number of clusters, and identifying a mapping between elements of the first plurality of cluster vectors and elements the second plurality of cluster vectors having a same dimension. The operations also include calculating, for each dimension based at least in part on the mapping, a dimensional distance between the first data set and the second data set and calculating, based at least in part on the dimensional distances, an ensemble distance between first data set and the second data set.

Embodiments of the present invention are directed to a computing system including a processor, a memory coupled to the processor and one or more computer readable storage media coupled to the processor. The one or more computer readable storage media collectively contain instructions that are executed by the processor via the memory to cause the processor to perform operations. The operations include obtaining a first data set and a second data set, inputting the first data set into each of a plurality of clustering models, wherein each of the plurality of clustering models separates the first data set into a different number of clusters, and storing an output of each of the plurality of clustering models corresponding to the first data set into a first plurality of cluster vectors, where each of the first plurality of cluster vectors has a dimension that corresponds to the number of clusters. The operations also include inputting the second data set into each of the plurality of clustering models, wherein each of the plurality of clustering models separates the second data set into a different number of clusters, storing the output of each of the plurality of clustering models corresponding to the second data set into a second plurality of cluster vectors, where each of the second plurality of cluster vectors has a dimension that corresponds to the number of clusters, and identifying a mapping between elements of the first plurality of cluster vectors and elements the second plurality of cluster vectors having a same dimension. The operations also include calculating, for each dimension based at least in part on the mapping, a dimensional distance between the first data set and the second data set and calculating, based at least in part on the dimensional distances, an ensemble distance between first data set and the second data set.

Embodiments of the present invention are directed to a computer-implemented method for performing a data difference evaluation. The computer-implemented method includes obtaining a first data set and a second data set, creating a first plurality of feature vectors by inputting the first data set into each of a plurality of models, wherein each of the plurality of models calculates a first number of features that each correspond to an element of one of the first plurality of vectors, and creating a second plurality of feature vectors by inputting the second data set into each of the plurality of models, wherein each of the plurality of models calculates a second number of features that each that each correspond to an element of one of the second plurality of feature vectors. The method also includes identifying a mapping between elements of the first plurality of vectors and elements the second plurality of feature vectors created by a same model of the plurality of models, calculating, for each of the plurality of models based at least in part on the mapping, a model distance between the first data set and the second data set, and calculating, based at least in part on the model distances, an ensemble distance between first data set and the second data set.

Embodiments of the present invention are directed to a computer-implemented method for performing a data difference evaluation. The computer-implemented method includes obtaining a first data set and a second data set, creating a first cluster vector, having a first dimension, for the first data set by inputting the first data set into a first clustering model, wherein the first clustering model separates the first data set into a first number of clusters that each correspond to an element of the first cluster vector and creating a second cluster vector, having a second dimension, for the first data set by inputting the first data set into a second clustering model, wherein the second clustering model separates the first data set into a second number of clusters that each correspond to an element of the second cluster vector. The method also includes creating a third cluster vector, having the first dimension, for the second data set by inputting the second data set into the first clustering model, wherein the first clustering model separates the second data set into the first number of clusters that each correspond to an element of the third cluster vector and creating a fourth cluster vector, having the second dimension, for the second data set by inputting the second data set into the second clustering model, wherein the second clustering model separates the second data set into the second number of clusters that each correspond to an element of the fourth cluster vector. The method further includes identifying a first mapping between elements of the first cluster vector and elements the third cluster vector and a second mapping between elements of the second cluster vector and elements the fourth cluster vector, calculating a first dimensional distance between the first cluster vector and the third cluster vector based on at least in part on the first mapping, calculating a second dimensional distance between the second cluster vector and the fourth cluster vector based on at least in part on the second mapping, and calculating, based at least in part on the first dimensional distance and the second dimensional distance, an ensemble distance between first data set and the second data set.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 is a schematic diagram of a computing environment in accordance with one or more embodiments of the present invention;

FIG. 2 is a block diagram illustrating a system for performing a data difference evaluation in accordance with one or more embodiments of the present invention;

FIGS. 3A and 3B are schematic diagrams illustrating the creation of cluster vectors having different dimensions based on input data sets in accordance with one or more embodiments of the present invention;

FIGS. 4A, 4B, and 4C are schematic diagrams illustrating mappings between elements of pairs of the cluster vectors in accordance with one or more embodiments of the present invention;

FIG. 5 is a flow diagram illustrating a computer-implemented method for performing a data difference evaluation in accordance with one or more embodiments of the present invention;

FIG. 6 is a flow diagram illustrating a computer-implemented method for performing a data difference evaluation in accordance with one or more embodiments of the present invention; and

FIGS. 7A and 7B are flow diagrams illustrating a computer-implemented performing a data difference evaluation in accordance with one or more embodiments of the present invention.

The diagrams depicted herein are illustrative. There can be many variations to the diagram or the operations described therein without departing from the spirit of the invention. For instance, the actions can be performed in a differing order, or actions can be added, deleted, or modified. Also, the term “coupled” and variations thereof describes having a communications path between two elements and does not imply a direct connection between the elements with no intervening elements/connections between them. All of these variations are considered a part of the specification.

### DETAILED DESCRIPTION

As discussed above, data difference evaluation is a common problem in the area of data science. One approach to evaluating the differences in data sets is to input different data sets into a model and compare the outputs of the model to infer the differences in the input data sets. In general, there are several different types of models that can be used for this type of data difference evaluation. Such models include classification models, regression models, clustering models, association rules models, and time series models. In addition, each of these types of models may include many different model implementations. As a result, the quality of the data difference evaluation using model comparison often depends on the type and implementation of the model used. For example, one model type may correctly indicate that two data sets are very similar while another model type may incorrectly indicate that the same two data sets are not similar.

In exemplary embodiments, systems, methods, and computer program products for data difference evaluation via model comparison are provided. In exemplary embodiments, two data sets are each input into a plurality of models. The plurality of models creates a set of feature vectors, where each feature vector corresponds to a data set and a model. Each pair of feature vectors that corresponds to a common model and different data sets are compared to determine the distance between the paired feature vectors. An ensemble distance is calculated based on the distances for each of the models, where the ensemble distance represents the difference between the two data sets.

In exemplary embodiments, the plurality of models are clustering models, such as K-means clustering models, that have different values of K, i.e., the different clustering models separate the data sets into different number (K) clusters. As will be appreciated by those of skill in the art, other clustering models (e.g., spectral clustering or agglomerative clustering) and other types of models may also be used.

Embodiments of the present invention are directed to a computer-implemented method for performing a data difference evaluation. The computer-implemented method includes obtaining a first data set and a second data set, inputting the first data set into each of a plurality of clustering models, wherein each of the plurality of clustering models separates the first data set into a different number of clusters, and storing an output of each of the plurality of clustering models corresponding to the first data set into a first plurality of cluster vectors, where each of the first plurality of cluster vectors has a dimension that corresponds to the number of clusters. The method also includes inputting the second data set into each of the plurality of clustering models, wherein each of the plurality of clustering models separates the second data set into a different number of clusters, storing the output of each of the plurality of clustering models corresponding to the second data set into a second plurality of cluster vectors, where each of the second plurality of cluster vectors has a dimension that corresponds to the number of clusters, and identifying a mapping between elements of the first plurality of cluster vectors and elements the second plurality of cluster vectors having a same dimension. The method also includes calculating, for each dimension based at least in part on the mapping, a dimensional distance between the first data set and the second data set and calculating, based at least in part on the dimensional distances, an ensemble distance between first data set and the second data set. One technical benefit of performing a data difference evaluation using a plurality of different clustering models is that the accuracy of the calculated ensemble distance more accurately reflects the difference in the data sets by reducing the reliance on any single model.

Additionally, or alternatively, in embodiments of the present invention each of the elements of the first plurality of cluster vectors and the elements of the second plurality of cluster vectors each include a data cluster and wherein the mapping is identified based on a centroid for each data cluster. One technical benefit of mapping the elements of the cluster vectors to one another is an increase in the accuracy dimensional scores by ensuring that the distance between the corresponding vector elements is minimized.

Additionally, or alternatively, in embodiments of the present invention the dimensional distance between the first data set and the second data set for each dimension is calculated based on a size of the first data set, a size of the second data set, and a distance between the centroid of mapped elements of the first plurality of cluster vectors and elements of the second plurality of cluster vectors. One technical benefit of calculating the dimensional distances based on the distance between the centroid of mapped elements is an increase in the dimensional scores by ensuring that the distance between the corresponding vector elements is minimized.

Additionally, or alternatively, in embodiments of the present invention the ensemble distance between first data set and the second data set is calculated as an average of the dimensional distance for each dimension. One technical benefit of calculating the ensemble distance based on the average of the dimensional distance for each dimension is that ensemble distance more accurately reflects the difference in the data sets by reducing the reliance on any single model.

Additionally, or alternatively, in embodiments of the present invention the ensemble distance between first data set and the second data set is calculated as a weighted average of the dimensional distance for each dimension, where a weight applied to each dimensional distance is based on a cluster quality associated with each dimension. One technical benefit of calculating the ensemble distance based on a weighted average of the dimensional distance for each dimension is that ensemble distance more accurately reflects the difference in the data sets by scaling the importance of the dimensional distance for each model based on a quality of the model.

Additionally, or alternatively, in embodiments of the present invention the method also includes removing cluster vectors from the first plurality of cluster vectors and the second plurality of cluster vectors having a cluster quality below a threshold value. One technical benefit of removing cluster vectors from the first plurality of cluster vectors and the second plurality of cluster vectors having a cluster quality below a threshold value is an increase in accuracy of the ensemble distance by removing poor quality models from contributing to the ensemble distance.

Embodiments of the present invention are directed to a computer program product for performing a data difference evaluation. The computer program product includes one or more computer readable storage media having computer readable program code collectively stored on the one or more computer readable storage media. The computer readable program code is executed by a processor of a computer system to cause the computer system to perform operations. The operations include obtaining a first data set and a second data set, inputting the first data set into each of a plurality of clustering models, wherein each of the plurality of clustering models separates the first data set into a different number of clusters, and storing an output of each of the plurality of clustering models corresponding to the first data set into a first plurality of cluster vectors, where each of the first plurality of cluster vectors has a dimension that corresponds to the number of clusters. The operations also include inputting the second data set into each of the plurality of clustering models, wherein each of the plurality of clustering models separates the second data set into a different number of clusters, storing the output of each of the plurality of clustering models corresponding to the second data set into a second plurality of cluster vectors, where each of the second plurality of cluster vectors has a dimension that corresponds to the number of clusters, and identifying a mapping between elements of the first plurality of cluster vectors and elements the second plurality of cluster vectors having a same dimension. The operations also include calculating, for each dimension based at least in part on the mapping, a dimensional distance between the first data set and the second data set and calculating, based at least in part on the dimensional distances, an ensemble distance between first data set and the second data set. One technical benefit of performing a data difference evaluation using a plurality of different clustering models is that the accuracy of the calculated ensemble distance more accurately reflects the difference in the data sets by reducing the reliance on any single model.

Embodiments of the present invention are directed to a computing system including a processor, a memory coupled to the processor and one or more computer readable storage media coupled to the processor. The one or more computer readable storage media collectively contain instructions that are executed by the processor via the memory to cause the processor to perform operations. The operations include obtaining a first data set and a second data set, inputting the first data set into each of a plurality of clustering models, wherein each of the plurality of clustering models separates the first data set into a different number of clusters, and storing an output of each of the plurality of clustering models corresponding to the first data set into a first plurality of cluster vectors, where each of the first plurality of cluster vectors has a dimension that corresponds to the number of clusters. The operations also include inputting the second data set into each of the plurality of clustering models, wherein each of the plurality of clustering models separates the second data set into a different number of clusters, storing the output of each of the plurality of clustering models corresponding to the second data set into a second plurality of cluster vectors, where each of the second plurality of cluster vectors has a dimension that corresponds to the number of clusters, and identifying a mapping between elements of the first plurality of cluster vectors and elements the second plurality of cluster vectors having a same dimension. The operations also include calculating, for each dimension based at least in part on the mapping, a dimensional distance between the first data set and the second data set and calculating, based at least in part on the dimensional distances, an ensemble distance between first data set and the second data set. One technical benefit of performing a data difference evaluation using a plurality of different clustering models is that the accuracy of the calculated ensemble distance more accurately reflects the difference in the data sets by reducing the reliance on any single model.

Embodiments of the present invention are directed to a computer-implemented method for performing a data difference evaluation. The computer-implemented method includes obtaining a first data set and a second data set, creating a first plurality of feature vectors by inputting the first data set into each of a plurality of models, wherein each of the plurality of models calculates a first number of features that each correspond to an element of one of the first plurality of vectors, and creating a second plurality of feature vectors by inputting the second data set into each of the plurality of models, wherein each of the plurality of models calculates a second number of features that each that each correspond to an element of one of the second plurality of feature vectors. The method also includes identifying a mapping between elements of the first plurality of vectors and elements the second plurality of feature vectors created by a same model of the plurality of models, calculating, for each of the plurality of models based at least in part on the mapping, a model distance between the first data set and the second data set, and calculating, based at least in part on the model distances, an ensemble distance between first data set and the second data set. One technical benefit of performing a data difference evaluation using a plurality of different clustering models is that the accuracy of the calculated ensemble distance more accurately reflects the difference in the data sets by reducing the reliance on any single model.

Embodiments of the present invention are directed to a computer-implemented method for performing a data difference evaluation. The computer-implemented method includes obtaining a first data set and a second data set, creating a first cluster vector, having a first dimension, for the first data set by inputting the first data set into a first clustering model, wherein the first clustering model separates the first data set into a first number of clusters that each correspond to an element of the first cluster vector and creating a second cluster vector, having a second dimension, for the first data set by inputting the first data set into a second clustering model, wherein the second clustering model separates the first data set into a second number of clusters that each correspond to an element of the second cluster vector. The method also includes creating a third cluster vector, having the first dimension, for the second data set by inputting the second data set into the first clustering model, wherein the first clustering model separates the second data set into the first number of clusters that each correspond to an element of the third cluster vector and creating a fourth cluster vector, having the second dimension, for the second data set by inputting the second data set into the second clustering model, wherein the second clustering model separates the second data set into the second number of clusters that each correspond to an element of the fourth cluster vector. The method further includes identifying a first mapping between elements of the first cluster vector and elements the third cluster vector and a second mapping between elements of the second cluster vector and elements the fourth cluster vector, calculating a first dimensional distance between the first cluster vector and the third cluster vector based on at least in part on the first mapping, calculating a second dimensional distance between the second cluster vector and the fourth cluster vector based on at least in part on the second mapping, and calculating, based at least in part on the first dimensional distance and the second dimensional distance, an ensemble distance between first data set and the second data set. One technical benefit of performing a data difference evaluation using a plurality of different clustering models is that the accuracy of the calculated ensemble distance more accurately reflects the difference in the data sets by reducing the reliance on any single model.

Additionally, or alternatively, in embodiments of the present invention the elements of the first cluster vector and the elements of the third cluster vector each include a data cluster and wherein the first mapping is identified based on a centroid for each data cluster. One technical benefit of mapping the elements of the cluster vectors to one another is an increase in the accuracy dimensional scores by ensuring that the distance between the corresponding vector elements is minimized.

Additionally, or alternatively, in embodiments of the present invention the first dimensional distance is calculated based on a size of the first data set, a size of the second data set, and a distance between the centroids of mapped elements of the first cluster vector and elements of the third cluster vector. One technical benefit of calculating the dimensional distances based on the distance between the centroid of mapped elements is an increase in the dimensional scores by ensuring that the distance between the corresponding vector elements is minimized.

Additionally, or alternatively, in embodiments of the present invention the ensemble distance between first data set and the second data set is calculated as a weighted average of the first dimensional distance and the second dimensional distance, where a first weight applied to the first dimensional distance is based on a first cluster quality corresponding to the first cluster vector and a second weight applied to the second dimensional distance is based on a second cluster quality corresponding to the first cluster vector. One technical benefit of calculating the dimensional distances based on the distance between the centroid of mapped elements is an increase in the dimensional scores by ensuring that the distance between the corresponding vector elements is minimized.

Various aspects of the present disclosure are described by narrative text, flowcharts, block diagrams of computer systems, and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as performing a data difference evaluation (block 150). In addition to block 150, computing environment 100 includes, for example, computer 101, wide area network (WAN) 102, end user device (EUD) 103, remote server 104, public Cloud 105, and private Cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI), device set 123, storage 124, and Internet of Things (IoT) sensor set 125), and network module 115. Remote server 104 includes remote database 132. Public Cloud 105 includes gateway 130, Cloud orchestration module 131, host physical machine set 142, virtual machine set 143, and container set 144.

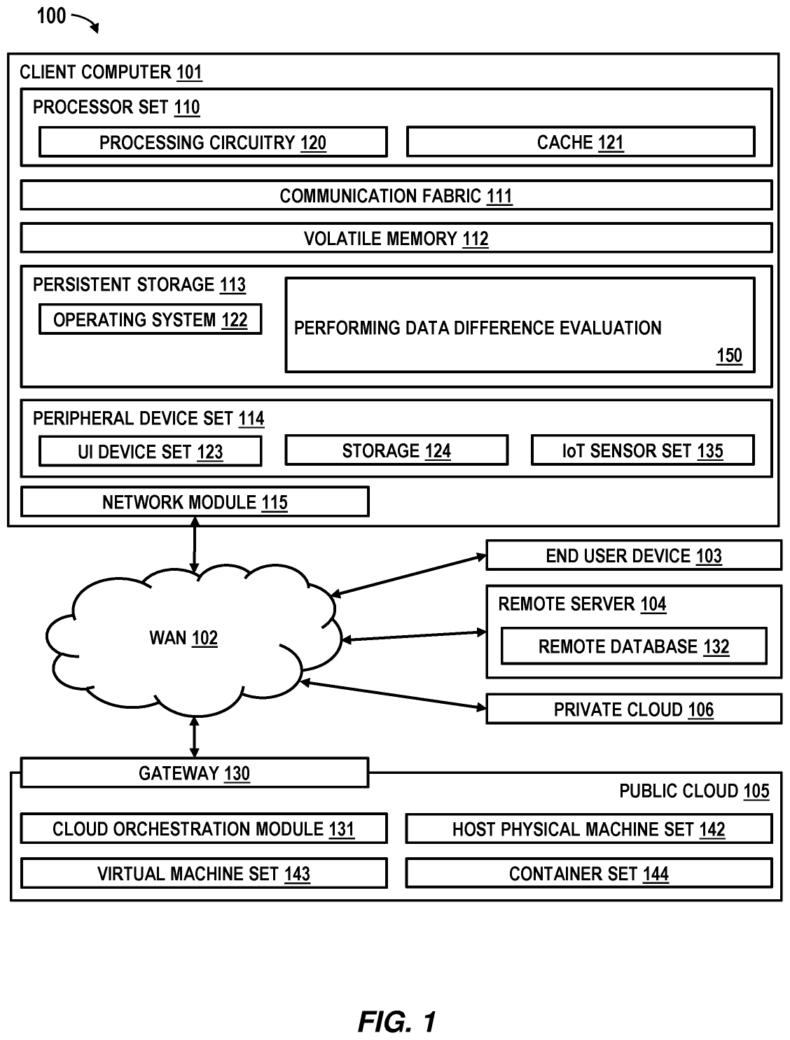

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 132. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a Cloud, even though it is not shown in a Cloud in FIG. 1. On the other hand, computer 101 is not required to be in a Cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collects and store helpful and useful data for use by other computers, such as computer 101. For example, in a hypothetical case where computer 101 is designed and programmed to provide a recommendation based on historical data, then this historical data may be provided to computer 101 from remote database 132 of remote server 104.

PUBLIC CLOUD 105 is any computer system available for use by multiple entities that provides on-demand availability of computer system resources and/or other computer capabilities, especially data storage (Cloud storage) and computing power, without direct active management by the user. Cloud computing typically leverages sharing of resources to achieve coherence and economies of scale. The direct and active management of the computing resources of public Cloud 105 is performed by the computer hardware and/or software of Cloud orchestration module 131. The computing resources provided by public Cloud 105 are typically implemented by virtual computing environments that run on various computers making up the computers of host physical machine set 142, which is the universe of physical computers in and/or available to public Cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 131 manages the transfer and storage of images, deploys new instantiations of VCEs and manages active instantiations of VCE deployments. Gateway 130 is the collection of computer software, hardware, and firmware that allows public Cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public Cloud 105, except that the computing resources are only available for use by a single enterprise. While private Cloud 106 is depicted as being in communication with WAN 102, in other embodiments a private Cloud may be disconnected from the internet entirely and only accessible through a local/private network. A hybrid Cloud is a composition of multiple Clouds of different types (for example, private, community or public Cloud types), often respectively implemented by different vendors. Each of the multiple Clouds remains a separate and discrete entity, but the larger hybrid Cloud architecture is bound together by standardized or proprietary technology that enables orchestration, management, and/or data/application portability between the multiple constituent Clouds. In this embodiment, public Cloud 105 and private Cloud 106 are both part of a larger hybrid Cloud.

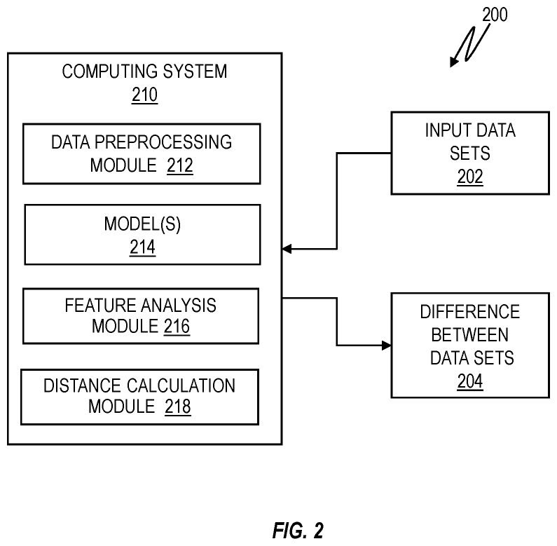

Referring now to FIG. 2, a block diagram illustrating a system 200 for performing a data difference evaluation in accordance with one or more embodiments of the present invention is shown. As illustrated, the system 200 includes a computing system 210 that is configured to receive input data sets 202 and to responsively calculate and output a difference between the data sets 204. In one embodiment, the difference between the data sets 204 is output as a percentage difference between the input data sets 202. In exemplary embodiments, the computing system 210 is embodied in a computer 101 such as the one shown in FIG. 1.

As illustrated, the computing system 201 includes a data preprocessing module 212, models 214, a feature analysis module 216, and a distance calculation module 218. In one embodiment, the data preprocessing module 212 is configured to receive the input data sets 202 and to perform preprocessing on the input data sets 202. For example, the preprocessing module 212 may be configured to identify missing values in the data set, outlier detection and/or removal, and feature scaling on the input data sets 202. Once the input data sets 202 have been preprocessed, the data sets are provided as inputs into the models 214.

In exemplary embodiments, the models 214 may include one or more of classification models, regression models, clustering models, association rules models and time series models. In one embodiment, the models 214 include a plurality of clustering models, such as K-means clustering models that have a range of values of K. A K-means clustering model is a popular unsupervised machine learning technique used for clustering data into K different groups or clusters based on their similarities.

In exemplary embodiments, each of the models 214 is configured to output a feature vector for each of the input data sets. For example, a set of five models 214 provided with two input data sets 202, will output ten feature vectors with each feature vector corresponding to a combination of one of the models 214 and one of the input data sets 202.

In one embodiment, the feature analysis module 216 of the computing system 210 is configured to analyze the feature vectors output by the models 214. In addition, the feature analysis module 216 may be configured to calculate a quality metric for each feature vector, where the quality metric represents how well the input data fits the model 214. In one example wherein the models 214 are K-means models, the feature analysis module 216 is configured to analyze the feature vector for each model to evaluate the quality of a K-means to determine its effectiveness in clustering the data. In one embodiment, the feature analysis module 216 calculates an average silhouette score for each K-means model, which is used as the quality metric for the K-means model. In general, a silhouette score measures how similar an object is to its cluster compared to other clusters and has a value from −1 to 1, where a higher score indicates better-defined clusters.

In exemplary embodiments, the feature analysis module 216 is configured to create a mapping between elements of feature vectors that correspond to different input data sets that were created by the same model. For example, a first feature vector created based on a first input data set and a first model includes five elements (E1, E2, E3, E4, and E5) and a second feature vector created based on a second input data set and a first model includes five elements (E1′, E2′, E3′, E4′, and E5′). The feature analysis module 216 is configured to create a mapping, or pairing, between the elements, such as (E1: E2′, E2: E4′, E3: E1′, E4: E3′, and E5: E5′). In one example, where the first model is a K-means clustering model with a K-value of 5, the mapping is determined by calculating a centroid location for each element/cluster and mapping elements/clusters having a minimum centroid distance to one another.

In exemplary embodiments, the distance calculation module 218 is configured to calculate a distance between two feature vectors that correspond to different input data sets that were created by the same model based on the mapping identified by the feature analysis module 216. In one example, the distance for a clustering model (D_{N}) is calculated as:

$${D}_{N} = \vert {K}_{n} - {K}_{N}^{′} \vert = {\sum }_{i = 1}^{N} ( {DCP}_{i} ⋆ \vert {DSC}_{i} / DS - {DSC}_{i}^{′} / {DS}^{′} \vert )$$

where N is a number of clusters, DCPi is the cluster centroids distance, DS is the size of the first data set, DS′ is the size of the second data set, DSCi is the size of the i^{th} cluster of first data set, and DSCi′ is the size of the i^{th} cluster of the second data set. In exemplary embodiments, the distance calculation module 218 is further configured to calculate a difference between the input data sets 204, also referred to herein as an ensemble distance. The difference between the input data sets 204 is calculated based on a combination of the distances calculated for each model 214. In one embodiment, the difference between the input data sets 204 (Dk) is a weighted average of the distance between the pairs of feature vectors and may be calculated as:

$$Dk = {\sum }_{i = 1}^{N} ( {D}_{N} ⋆ {W}_{N} ) / N$$

where N is a number of models, D_{N} is the distance for each model, Wn is the quality metric calculated by the feature analysis module 216 for each model. In one embodiment, the difference between the input data sets 204 (Dk) is the average of the distance between the pairs of feature vectors and may be calculated as:

$$Dk = {\sum }_{i = 1}^{N} ( {D}_{N} ) / N$$

where N is a number of models, D_{N} is the distance for each model.

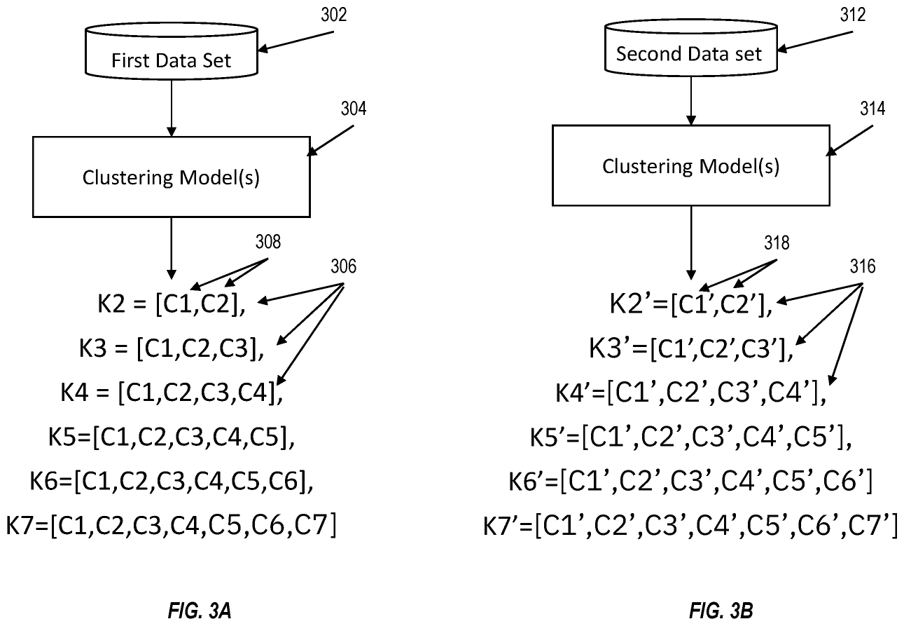

Referring now to FIGS. 3A and 3B, schematic diagrams illustrating the creation of cluster vectors having different dimensions based on input data sets in accordance with one or more embodiments of the present invention are shown. As shown in FIG. 3A, a first data set 302 is input into a plurality of clustering models 304. In one embodiment, the plurality of clustering models 304 includes K-means clustering models having a range of values of K from two to seven. Each of the plurality of clustering models 304 creates a cluster vector 306 that includes a number of elements 308 that each represent a cluster of data. The number of elements 308 in each cluster vector 306 corresponds to the K value of the clustering model 304 used to create the cluster vector 306. Likewise, as shown in FIG. 3B, a second data set 312 is input into a plurality of clustering models 314. In one embodiment, the plurality of clustering models 314 includes K-means clustering models having a range of values of K from two to seven. Each of the plurality of clustering models 314 creates a cluster vector 316 that includes a number of elements 318 that each represent a cluster of data. The number of elements 318 in each cluster vector 316 corresponds to the K value of the clustering model 314 used to create the cluster vector 316.

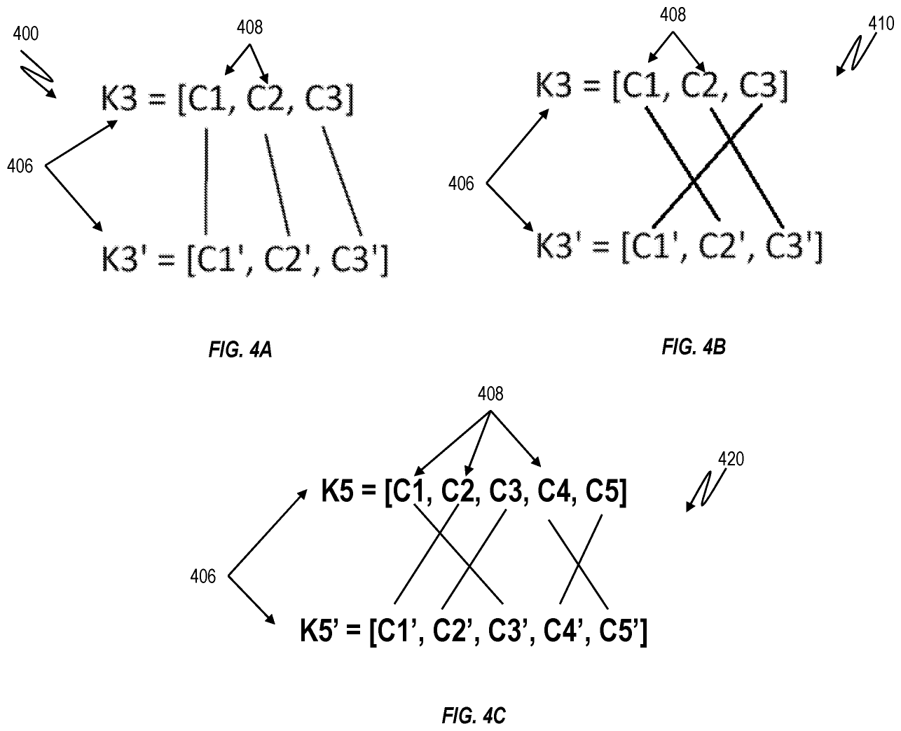

Referring now to FIGS. 4A, 4B, and 4C, schematic diagrams illustrating mappings between elements of pairs of the cluster vectors and in accordance with one or more embodiments of the present invention are shown. As shown in FIGS. 4A, 4B, and 4C, respectively, mappings 400, 410, and 420 between two feature vectors 406, also referred to herein a cluster vectors, includes a one-to-one correspondence between the elements 408 of the feature vectors 406. In one embodiment, each element 408 of the feature vector 406 represents a cluster of data and the correspondence between the elements 408 is determined based on comparing the centroid of the clusters of data. For example, the mapping may be determined by minimizing a total distance between each centroid pair.

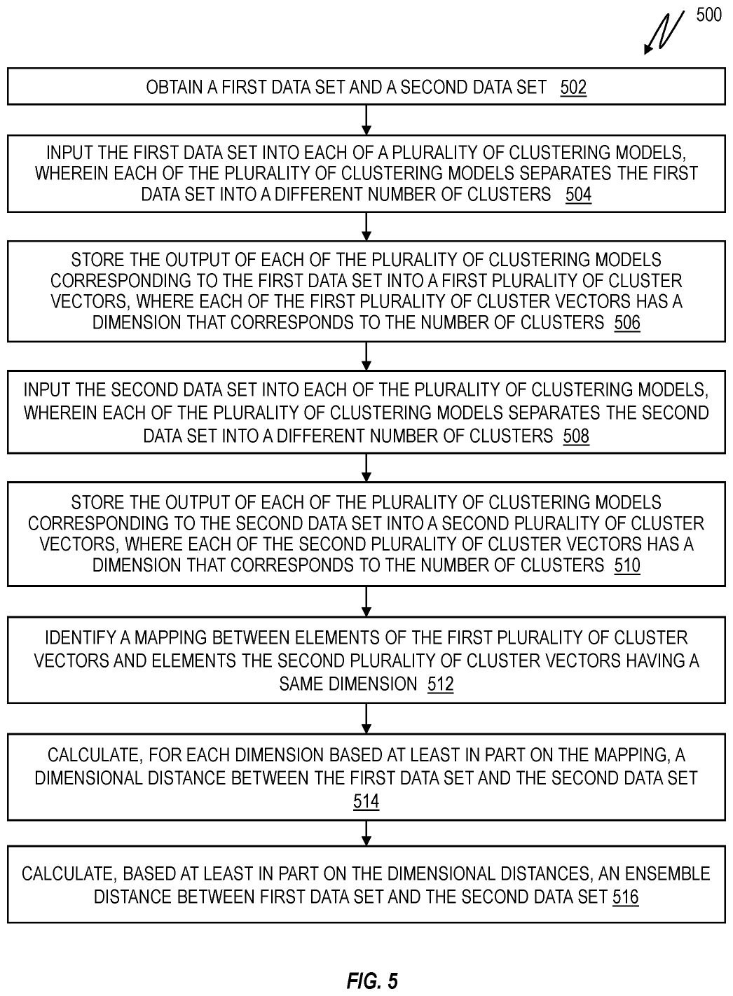

Referring now to FIG. 5, a flow diagram illustrating a computer-implemented method 500 for performing a data difference evaluation in accordance with one or more embodiments of the present invention is shown. In exemplary embodiments, the method 500 is performed by a computing system 210, such as the one shown in FIG. 2. At block 502, the method 500 includes obtaining a first data set and a second data set. Next, as shown at block 504 inputting the first data set into each of a plurality of clustering models, where each of the plurality of clustering models separates the first data set into a different number of clusters. In one embodiment, each of the plurality of clustering models are K-means clustering models that have different values of K. At block 506, the method 500 includes storing the output of each of the plurality of clustering models corresponding to the first data set into a first plurality of cluster vectors, where each of the first plurality of cluster vectors has a dimension that corresponds to the number of clusters.

Next, as shown at block 508, the method 500 includes inputting the second data set into each of the plurality of clustering models, wherein each of the plurality of clustering models separates the second data set into a different number of clusters. At block 510 the method 500 includes storing the output of each of the plurality of clustering models corresponding to the second data set into a second plurality of cluster vectors, where each of the second plurality of cluster vectors has a dimension that corresponds to the number of clusters.

The method 500 includes identifying a mapping between elements of the first plurality of cluster vectors and elements the second plurality of cluster vectors having a same dimension, as shown at block 512. In exemplary embodiments, each of the elements of the first plurality of cluster vectors and the elements of the second plurality of cluster vectors each include a data cluster and the mapping is identified based on a centroid for each data cluster.

Next, as shown at block 514, the method 500 includes calculating, for each dimension based at least in part on the mapping, a dimensional distance between the first data set and the second data set. In one embodiment, the dimensional distance between the first data set and the second data set for each dimension is calculated based on a size of the first data set, a size of the second data set, and a distance between the centroid of mapped elements of the first plurality of cluster vectors and elements of the second plurality of cluster vectors. Each dimensional distance calculated corresponds to one of the plurality of clustering models and indicates how close the first data set is to the second data set when analyzed by the corresponding model.

As shown at block 516, the method 500 includes calculating, based at least in part on the dimensional distances, an ensemble distance between first data set and the second data set. In one embodiment, the ensemble distance between first data set and the second data set is calculated as an average of the dimensional distance for each dimension. In another embodiment, the ensemble distance between first data set and the second data set is calculated as a weighted average of the dimensional distance for each dimension, where a weight applied to each dimensional distance is based on a cluster quality associated with each dimension. In exemplary embodiments, the ensemble distance indicates the average, or weighted average, distance between the first and second input data sets.

In exemplary embodiments, the method 500 may also include removing cluster vectors from the first plurality of cluster vectors and the second plurality of cluster vectors having a cluster quality below a threshold value. In one embodiment, a quality metric is calculated for each of the first and second plurality of the cluster vectors. After the quality metrics are calculated and prior to identifying a mapping between the cluster vectors, cluster vectors that have a quality metric that fails to meet a threshold value are removed from the set of cluster vectors.

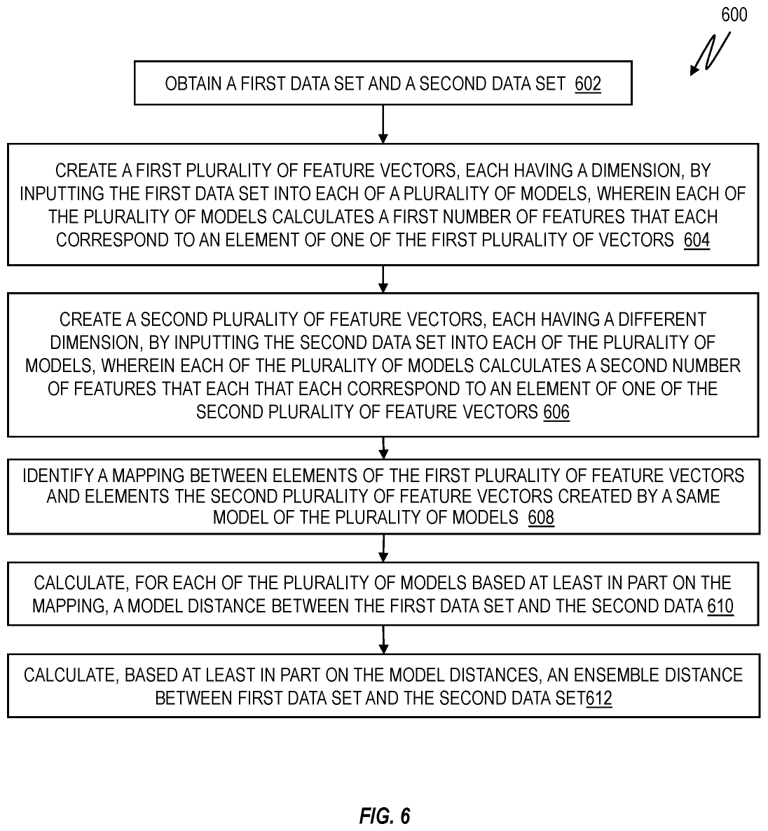

Referring now to FIG. 6 is a flow diagram illustrating a computer-implemented method 600 for performing a data difference evaluation in accordance with one or more embodiments of the present invention is shown. In exemplary embodiments, the method 500 is performed by a computing system 210, such as the one shown in FIG. 2. At block 602, the method 600 includes obtaining a first data set and a second data set.

Next, as shown at block 604, the method 600 includes creating a first plurality of feature vectors by inputting the first data set into each of a plurality of models. In exemplary embodiments, each of the plurality of models calculates a number of features that each correspond to an element of one of the first plurality of vectors. In one embodiment, the plurality of models are clustering models and the features are characteristics of clusters of data identified by the clustering models.

As shown at block 606, the method 600 includes creating a second plurality of feature vectors by inputting the second data set into each of the plurality of models. In exemplary embodiments, each of the plurality of models calculates a different number of features that each that each correspond to an element of one of the second plurality of feature vectors. In one embodiment, the plurality of models are clustering models and the features are characteristics of clusters of data identified by the clustering models.

Next, as shown at block 608, the method 600 includes identifying a mapping between elements of the first plurality of feature vectors and elements the second plurality of feature vectors created by a same model of the plurality of models. Once the mapping of the elements between the feature vectors have been identified, the method 600 includes calculating, for each of the plurality of models based at least in part on the mapping, a model distance between the first data set and the second data set, as shown at block 610. In exemplary embodiments, the calculated model distance indicates how close the first data set is to the second data set when analyzed by the corresponding model.

At block 612, the method 600 concludes by calculating, based at least in part on the model distances, an ensemble distance between first data set and the second data set. In one embodiment, the ensemble distance between first data set and the second data set is calculated as an average of the model distance for each of the plurality of models. In another embodiment, the ensemble distance between first data set and the second data set is calculated as a weighted average of the model distance for each of the plurality of models, where a weight applied to each model distance is based on a quality metric that is calculated for each model. In exemplary embodiments, the ensemble distance indicates the average, or weighted average, distance between the first and second input data sets.

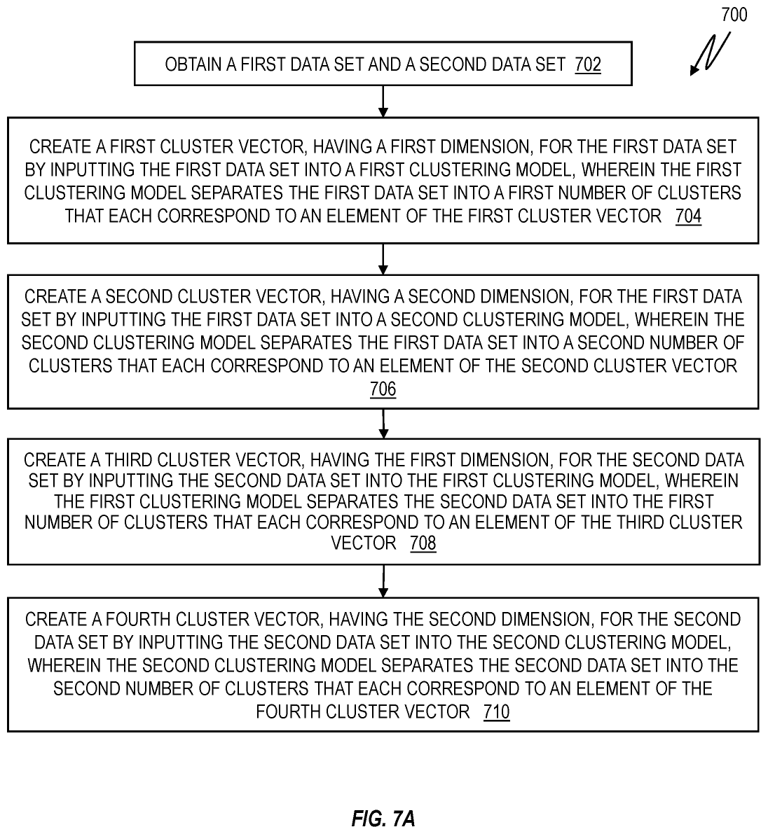

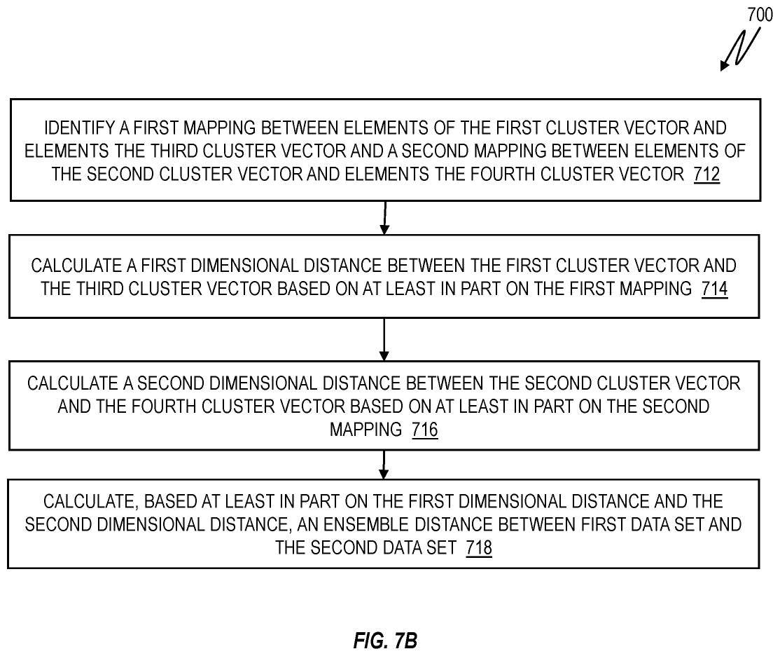

Referring now to FIGS. 7A and 7B are flow diagrams illustrating a computer-implemented method 700 for performing a data difference evaluation in accordance with one or more embodiments of the present invention is shown. In exemplary embodiments, the method 700 is performed by a computing system 210, such as the one shown in FIG. 2. At block 702, the method 700 includes obtaining a first data set and a second data set.

As shown at block 704, the method 700 includes creating a first cluster vector, having a first dimension, for the first data set by inputting the first data set into a first clustering model. In exemplary embodiments, the first clustering model separates the first data set into a first number of clusters that each correspond to an element of the first cluster vector.

As shown at block 706, the method 700 includes creating a second cluster vector, having a second dimension, for the first data set by inputting the first data set into a second clustering model. In exemplary embodiments, the second clustering model separates the first data set into a second number of clusters that each correspond to an element of the second cluster vector.

As shown at block 708, the method 700 includes creating a third cluster vector, having the first dimension, for the second data set by inputting the second data set into the first clustering model. In exemplary embodiments, the first clustering model separates the second data set into the first number of clusters that each correspond to an element of the third cluster vector.

As shown at block 710, the method 700 includes creating a fourth cluster vector, having the second dimension, for the second data set by inputting the second data set into the second clustering model. In exemplary embodiments, the second clustering model separates the second data set into the second number of clusters that each correspond to an element of the fourth cluster vector.

As shown at block 712, the method 700 includes identifying a first mapping between elements of the first cluster vector and elements the third cluster vector and a second mapping between elements of the second cluster vector and elements the fourth cluster vector. In exemplary embodiments, the elements of the first cluster vector and the elements of the third cluster vector each include a data cluster and the first mapping is identified based on a centroid for each data cluster. In exemplary embodiments, the elements of the second cluster vector and the elements of the fourth cluster vector each include a data cluster and the second mapping is identified based on a centroid for each data cluster.

As shown at block 714, the method 700 includes calculating a first dimensional distance between the first cluster vector and the third cluster vector based on at least in part on the first mapping. In exemplary embodiments, the first dimensional distance is calculated based on a size of the first data set, a size of the second data set, and a distance between the centroids of mapped elements of the first cluster vector and elements of the third cluster vector.

As shown at block 716, the method 700 includes calculating a second dimensional distance between the second cluster vector and the fourth cluster vector based on at least in part on the second mapping. In exemplary embodiments, the second dimensional distance is calculated based on a size of the first data set, a size of the second data set, and a distance between the centroids of mapped elements of the second cluster vector and elements of the fourth cluster vector.

As shown at block 716, the method 700 includes calculating, based at least in part on the first dimensional distance and the second dimensional distance, an ensemble distance between first data set and the second data set. In one embodiment, the ensemble distance between first data set and the second data set is calculated as a weighted average of the first dimensional distance and the second dimensional distance, where a first weight applied to the first dimensional distance is based on a first cluster quality corresponding to the first cluster vector and a second weight applied to the second dimensional distance is based on a second cluster quality corresponding to the first cluster vector. In another embodiment, the ensemble distance between first data set and the second data set is calculated as the average of the first dimensional distance and the second dimensional distance.

In exemplary embodiments, once the ensemble distance has been calculated, it can be compared to a threshold value to determine whether the first data set and the second data set are determined to be closely related. In one embodiment, the threshold value is provided by a data scientist based on a type of analysis being performed. In one embodiment, the threshold value is provided as a percentage. In exemplary embodiments, based on a determination that the ensemble distance is greater than the threshold value, the dimensional distances are provided to the data scientist for further analysis.

In exemplary embodiments, by evaluating the similarity between two data sets using multiple types and/or configurations of models, rather than a single model, a more accurate and comprehensive evaluation of the similarity of the data set is achieved. In addition, performing the evaluation using multiple models and combining the output of the multiple models based on a quality metric of each of the models further enhances the accuracy and reliability of the calculated similarity.

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” may be understood to include any integer number greater than or equal to one, i.e. one, two, three, four, etc. The terms “a plurality” may be understood to include any integer number greater than or equal to two, i.e. two, three, four, five, etc. The term “connection” may include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A computer-implemented method for data difference evaluation, the computer-implemented method comprising:
obtaining a first data set and a second data set;
inputting the first data set into each of a plurality of clustering models, wherein each of the plurality of clustering models separates the first data set into a different number of clusters;
storing an output of each of the plurality of clustering models corresponding to the first data set into a first plurality of cluster vectors, where each of the first plurality of cluster vectors has a dimension that corresponds to the number of clusters;
inputting the second data set into each of the plurality of clustering models, wherein each of the plurality of clustering models separates the second data set into a different number of clusters;
storing the output of each of the plurality of clustering models corresponding to the second data set into a second plurality of cluster vectors, where each of the second plurality of cluster vectors has a dimension that corresponds to the number of clusters;
identifying a mapping between elements of the first plurality of cluster vectors and elements the second plurality of cluster vectors having a same dimension;
calculating, for each dimension based at least in part on the mapping, a dimensional distance between the first data set and the second data set; and
calculating, based at least in part on the dimensional distances, an ensemble distance between first data set and the second data set.

2. The computer-implemented method of claim 1, wherein each of the elements of the first plurality of cluster vectors and the elements of the second plurality of cluster vectors each include a data cluster and wherein the mapping is identified based on a centroid for each data cluster.

3. The computer-implemented method of claim 2, wherein the dimensional distance between the first data set and the second data set for each dimension is calculated based on a size of the first data set, a size of the second data set, and a distance between the centroid of mapped elements of the first plurality of cluster vectors and elements of the second plurality of cluster vectors.

4. The computer-implemented method of claim 1, wherein the ensemble distance between first data set and the second data set is calculated as an average of the dimensional distance for each dimension.

5. The computer-implemented method of claim 1, wherein the ensemble distance between first data set and the second data set is calculated as a weighted average of the dimensional distance for each dimension, where a weight applied to each dimensional distance is based on a cluster quality associated with each dimension.

6. The computer-implemented method of claim 1, further comprising removing cluster vectors from the first plurality of cluster vectors and the second plurality of cluster vectors having a cluster quality below a threshold value.

7. The computer-implemented method of claim 1, wherein the plurality of clustering models are K-means clustering models.

8. A computer program product having one or more computer readable storage media having computer readable program code collectively stored on the one or more computer readable storage media, the computer readable program code being executed by a processor of a computer system to cause the computer system to perform operations comprising:
obtaining a first data set and a second data set;
inputting the first data set into each of a plurality of clustering models, wherein each of the plurality of clustering models separates the first data set into a different number of clusters;
storing an output of each of the plurality of clustering models corresponding to the first data set into a first plurality of cluster vectors, where each of the first plurality of cluster vectors has a dimension that corresponds to the number of clusters;
inputting the second data set into each of the plurality of clustering models, wherein each of the plurality of clustering models separates the second data set into a different number of clusters;
storing the output of each of the plurality of clustering models corresponding to the second data set into a second plurality of cluster vectors, where each of the second plurality of cluster vectors has a dimension that corresponds to the number of clusters;
identifying a mapping between elements of the first plurality of cluster vectors and elements the second plurality of cluster vectors having a same dimension;
calculating, for each dimension based at least in part on the mapping, a dimensional distance between the first data set and the second data set; and
calculating, based at least in part on the dimensional distances, an ensemble distance between first data set and the second data set.

9. The computer program product of claim 8, wherein each of the elements of the first plurality of cluster vectors and the elements of the second plurality of cluster vectors each include a data cluster and wherein the mapping is identified based on a centroid for each data cluster.

10. The computer program product of claim 9, wherein the dimensional distance between the first data set and the second data set for each dimension is calculated based on a size of the first data set, a size of the second data set, and a distance between the centroid of mapped elements of the first plurality of cluster vectors and elements of the second plurality of cluster vectors.

11. The computer program product of claim 8, wherein the ensemble distance between first data set and the second data set is calculated as an average of the dimensional distance for each dimension.

12. The computer program product of claim 8, wherein the ensemble distance between first data set and the second data set is calculated as a weighted average of the dimensional distance for each dimension, where a weight applied to each dimensional distance is based on a cluster quality associated with each dimension.

13. The computer program product of claim 8, wherein the operations further comprise removing cluster vectors from the first plurality of cluster vectors and the second plurality of cluster vectors having a cluster quality below a threshold value.

14. The computer program product of claim 8, wherein the plurality of clustering models are K-means clustering models.

15. A computing system comprising:
a processor;
a memory coupled to the processor; and
one or more computer readable storage media coupled to the processor, the one or more computer readable storage media collectively containing instructions that are executed by the processor via the memory to cause the processor to perform operations comprising:
obtaining a first data set and a second data set;
inputting the first data set into each of a plurality of clustering models, wherein each of the plurality of clustering models separates the first data set into a different number of clusters;
storing an output of each of the plurality of clustering models corresponding to the first data set into a first plurality of cluster vectors, where each of the first plurality of cluster vectors has a dimension that corresponds to the number of clusters;
inputting the second data set into each of the plurality of clustering models, wherein each of the plurality of clustering models separates the second data set into a different number of clusters;
storing the output of each of the plurality of clustering models corresponding to the second data set into a second plurality of cluster vectors, where each of the second plurality of cluster vectors has a dimension that corresponds to the number of clusters;
identifying a mapping between elements of the first plurality of cluster vectors and elements the second plurality of cluster vectors having a same dimension;
calculating, for each dimension based at least in part on the mapping, a dimensional distance between the first data set and the second data set; and
calculating, based at least in part on the dimensional distances, an ensemble distance between first data set and the second data set.

16. The computer system of claim 15, wherein each of the elements of the first plurality of cluster vectors and the elements of the second plurality of cluster vectors each include a data cluster and wherein the mapping is identified based on a centroid for each data cluster.

17. The computer system of claim 16, wherein the dimensional distance between the first data set and the second data set for each dimension is calculated based on a size of the first data set, a size of the second data set, and a distance between the centroid of mapped elements of the first plurality of cluster vectors and elements of the second plurality of cluster vectors.

18. The computer system of claim 15, wherein the ensemble distance between first data set and the second data set is calculated as an average of the dimensional distance for each dimension.

19. The computer system of claim 15, wherein the ensemble distance between first data set and the second data set is calculated as a weighted average of the dimensional distance for each dimension, where a weight applied to each dimensional distance is based on a cluster quality associated with each dimension.

20. The computer system of claim 15, wherein the operations further comprise removing cluster vectors from the first plurality of cluster vectors and the second plurality of cluster vectors having a cluster quality below a threshold value.

21. A computer-implemented method for data difference evaluation, the computer-implemented method comprising:
obtaining a first data set and a second data set;
creating a first plurality of feature vectors by inputting the first data set into each of a plurality of models, wherein each of the plurality of models calculates a first number of features that each correspond to an element of one of the first plurality of vectors;
creating a second plurality of feature vectors by inputting the second data set into each of the plurality of models, wherein each of the plurality of models calculates a second number of features that each that each correspond to an element of one of the second plurality of feature vectors;
identifying a mapping between elements of the first plurality of vectors and elements the second plurality of feature vectors created by a same model of the plurality of models;
calculating, for each of the plurality of models based at least in part on the mapping, a model distance between the first data set and the second data set; and
calculating, based at least in part on the model distances, an ensemble distance between first data set and the second data set.

22. A computer-implemented method for data difference evaluation, the computer-implemented method comprising:
obtaining a first data set and a second data set;
creating a first cluster vector, having a first dimension, for the first data set by inputting the first data set into a first clustering model, wherein the first clustering model separates the first data set into a first number of clusters that each correspond to an element of the first cluster vector;
creating a second cluster vector, having a second dimension, for the first data set by inputting the first data set into a second clustering model, wherein the second clustering model separates the first data set into a second number of clusters that each correspond to an element of the second cluster vector;
creating a third cluster vector, having the first dimension, for the second data set by inputting the second data set into the first clustering model, wherein the first clustering model separates the second data set into the first number of clusters that each correspond to an element of the third cluster vector;
creating a fourth cluster vector, having the second dimension, for the second data set by inputting the second data set into the second clustering model, wherein the second clustering model separates the second data set into the second number of clusters that each correspond to an element of the fourth cluster vector;
identifying a first mapping between elements of the first cluster vector and elements the third cluster vector and a second mapping between elements of the second cluster vector and elements the fourth cluster vector;
calculating a first dimensional distance between the first cluster vector and the third cluster vector based on at least in part on the first mapping;
calculating a second dimensional distance between the second cluster vector and the fourth cluster vector based on at least in part on the second mapping; and
calculating, based at least in part on the first dimensional distance and the second dimensional distance, an ensemble distance between first data set and the second data set.

23. The computer-implemented method of claim 22, wherein the elements of the first cluster vector and the elements of the third cluster vector each include a data cluster and wherein the first mapping is identified based on a centroid for each data cluster.

24. The computer-implemented method of claim 23, wherein the first dimensional distance is calculated based on a size of the first data set, a size of the second data set, and a distance between the centroids of mapped elements of the first cluster vector and elements of the third cluster vector.

25. The computer-implemented method of claim 22, wherein the ensemble distance between first data set and the second data set is calculated as a weighted average of the first dimensional distance and the second dimensional distance, where a first weight applied to the first dimensional distance is based on a first cluster quality corresponding to the first cluster vector and a second weight applied to the second dimensional distance is based on a second cluster quality corresponding to the first cluster vector.
